(19) United States
(12) Patent Application Publication
(10) Pub. No.: US 2014/0259688 A1
(43) Pub. Date: Sep. 18, 2014

(54) Self-Opening Nipper and Method for Manufacturing Self-Opening Nipper

(71) Applicant: Tweezerman International, LLC, Port Washington, NY (US)

(72) Inventor: Sebastian Mader, Hilden (DE)

(21) Appl. No.: 13/799,507

(22) Filed: Mar. 13, 2013

(51) Int. Cl. B26B 17/00

(52) U.S. Cl. CPC B26B 17/00
USPC 30/186; 76/104.1

(57) ABSTRACT

A nipper includes two crossing levers movably connected at a joint, each lever has a finished distal portion with a blade, an unfinished proximal portion, and a coil-spring connector at a junction of the distal and proximal portions. A hollow coil spring has ends each connected to a respective connector and visually covering the proximal portion thereof. A method for manufacturing the nipper includes providing the levers with a nipper blade at the finished distal portion, the unfinished proximal portion at a proximal end of the distal portion, and the coil-spring connector at a junction of the distal and proximal portions. The two levers are movably connected at the joint to form a nipper with the blades. The proximal portion of each lever is visually covered by sliding each end of the coil spring over the respective proximal portion and securing each end thereof at the respective coil-spring connector.

### STATEMENT REGARDING FEDERALLY SPONSORED RESEARCH OR DEVELOPMENT

Not Applicable

### FIELD OF THE INVENTION

The present invention lies in the field of beauty tools. The present disclosure relates to a self-opening nipper and methods for manufacturing same.

### BACKGROUND OF THE INVENTION

In the field of beauty tools, nippers are mainly used to nip nails and cuticles. High-quality nippers are mostly made of two pieces of stainless steel, which are joined together to create a crossing structure. Examples of such nippers are illustrated in FIGS. 1 and 2. On one side of the pivot joint 1, the levers 2, 3 have surfaces 4, 5 that can act as blades. These blades can be forced together to provide a cutting or nipping edge by moving the handles 6, 7 that are disposed on the side of the joint 1 opposite the blades 4, 5. In most cases, there is an additional spring system 8 that opens up the nipper at least partially when the handles 6, 7 are not being forced together. This spring system 8 ensures that the user merely needs to take care of the step of closing the nipper, by forcing the two handles together, to effect the cutting/nipping. When the force is released, the nipper automatically opens due to the spring system, as shown, for example, in FIG. 4.

Known spring systems are bent or spiral spring systems that are placed in-between the two handles, as shown, for example, in FIGS. 1, 3, and 4, or that are implemented into the joint, as shown, for example, in FIG. 2.

There are many disadvantages associated with the existing concepts. In production, a significant amount of time and cost are consumed by the finishing processes of the handles. Due to the complex geometry and the defined surface structure needed, these processes are mainly done manually, which makes them even more time and cost intensive. These processes also increase the second class and scrap rate because, during the last finishing process (a step after most of the processing costs have already been invested in the piece) inclusions can become visible. Most of the existing spring systems are made out of several pieces, as shown, for example, in FIG. 3. The large number of pieces is another reason for high cost and high complexity. Further, the existing spring systems are small because they need to fit in-between the handles or even within the joint. Due to the small dimensions, the springs are stressed highly, which results in:
a strong increase of closing force during the closing (overcoming this high closing force is uncomfortable and leads to quickly tiring hand muscles); and
high mechanical stresses within the spring, which tends to weaken or even break over the typical time of nipper usage.
   Moreover, the handles, themselves, get slippery, especially when they are handled with wet or oily hands. Finally, the open end of the handles reduces ergonomic comfort and control.

Thus, a need exists to overcome the problems with the prior art systems, designs, and processes as discussed above.

### SUMMARY OF THE INVENTION

The invention provides a self-opening nipper and methods for manufacturing same that overcome the hereinafore-mentioned disadvantages of the heretofore-known devices and methods of this general type and that provide such features with less cost and time for manufacture, with less second class pieces and reduced scrap rate, with minimizing the piece count, and with less stress on the moving parts.

The new and innovative nipper concept and manufacturing methods differ from all existing ones by having one spiral spring cover both handles and generate a closed loop on the back side of those handles. This coil spring acts, on one hand, as a surface for the handles and, on the other hand, as an opening spring to open up the nipper in an un-forced condition. Compared to all existing nippers this concept offers fundamental advantages for ergonomics and production.

In case of the new and innovative concept, the handles only need to be machined at their front end close to the joint where the spring is clamped onto them. All the rest of each of the handles does not need to be grinded or polished at all because this surface is otherwise covered by the coil spring. Such a configuration significantly reduces time and cost intensive work processes as well as second-class and scrap rates. If desired, the unfinished ends of the handles can be coated, for example, by a plastic.

The coil spring itself can easily be produced by simple machines from, for example, steel alloy, aluminum alloy or plastic, at a high and constant quality level. Additionally the surface of the coil spring does not need to be grinded or polished because it has a high quality level right away. Complexity is significantly reduced because only one part for the spring system is needed. Further, due to the bigger size of the coil spring compared to existing spring systems, the spring is mechanically stressed much less, thereby creating a required closing force that is much less for closing of the nipper. This leads to an increased level of comfort and a reduction in tiring of the hand muscles. Furthermore, the reduced levels of mechanical stresses ensure that the new spring system withstands many more closing cycles without weakening or breakage as compared to the prior art. The coil spring offers a defined surface structure along the handles, which increases the grip. Especially in wet or oily conditions, the nipper tends to slip less often due to the closure form of the spirals.

Further, the closed back loop of the coil spring increases the contact zone between the hand and the nipper significantly, which results in greater control and a higher precision in handling and nipping, even when being used with the non-dominant hand.

With the foregoing and other objects in view, there is provided, in accordance with the invention, a nipper including two crossing levers movably connected at a joint, each of the levers having a finished distal portion having at least one blade, an unfinished proximal portion, and a coil-spring connector at a junction of the distal and proximal portions, and a coil spring having a hollow interior and two ends, each of the two ends being connected to a respective coil-spring connector and visually covering substantially all of a respective proximal portion. Accordingly, the spiral spring covers both handles and generates a closed loop on the back side of those handles.

With the objects of the invention in view, there is also provided a method for manufacturing a nipper, including the steps of providing each of two levers with a nipper blade at a finished distal portion having a proximal end, an unfinished proximal portion connected at the proximal end of the distal portion, and a coil-spring connector at a junction of the distal and proximal portions, movably connecting the two levers at a joint to form a nipper with the nipper blades, and visually covering substantially all of the proximal portion of each lever by sliding each end of a coil spring over the respective proximal portion and securing each end of the coil spring at the respective coil-spring connector

In accordance with another feature of the invention, the coil spring is at least one of a steel alloy, an aluminum alloy, and a plastic.

In accordance with a further feature of the invention, the coil spring is coated by at least one of paint, plastics, gold, silver, nickel, chrome, a carbide coating, and a nitride coating.

In accordance with an added feature of the invention, the coil spring has a length and is of a material having a thickness that varies along the length of the coil spring.

In accordance with an additional feature of the invention, the coil spring has a length and a cross diameter that varies along the length of the coil spring.

In accordance with yet another feature of the invention, the coil spring has a length and a cross-sectional shape of the spring not of a constant dimension along the length of the coil spring.

In accordance with yet a further feature of the invention, the coil spring has a round cross-sectional shape along the length of the coil spring

In accordance with yet an added feature of the invention, the coil spring has a non-round cross-sectional shape along the length of the coil spring.

In accordance with yet an additional feature of the invention, the coil spring is flat at each of the two ends.

In accordance with again another feature of the invention, the proximal portions are plastic-coated.

In accordance with again a further mode of the invention, the two levers are provided as two mirror-symmetrical levers.

In accordance with a concomitant feature of the invention, the nipper blades are held apart with the coil spring in a steady-state of the nipper.

Although the invention is illustrated and described herein as embodied in a self-opening nipper and methods for manufacturing same, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a top plan view of a prior art nipper with a central leaf spring system;

FIG. 2 is top plan view of a prior art nipper with a multi-part central coil spring system;

FIG. 3 is a top plan view of the prior art nipper of FIG. 1 with the central leaf spring system disassembled;

FIG. 4 is a fragmentary, perspective view of the prior art nipper of FIG. 1 in a hand of a user with the spring retaining the nipper edges apart;

FIG. 5 is a partially cut-away, top plan view of an exemplary embodiment of a nipper with handles surrounded by a coil spring;

FIG. 6 is a photograph of a top plan view of an exemplary embodiment of a nipper;

FIG. 7 is a photograph of a right side view of the nipper of FIG. 6;

FIG. 8 is a photograph of a fragmentary, bottom plan view of the nipper of FIG. 6 in an open state within a hand of user;

FIG. 9 is a photograph of a fragmentary, bottom plan view of the nipper of FIG. 6 in a closed state within a hand of user;

FIG. 10 is a photograph of a fragmentary, top plan view of the nipper of FIG. 6 in the closed state within a hand of user;

FIG. 11 is a top plan view of one handle half of an exemplary embodiment of a nipper;

FIG. 12 is an outside elevational view of the handle half of FIG. 11;

FIG. 13 is an inside elevational view of the handle half of FIG. 11;

FIG. 14 is a bottom plan view of the handle half of FIG. 11;

FIG. 15 is a cross-sectional, perspective view of the handle half of FIG. 11 along section line A-A;

FIG. 16 is a cross-sectional view of the handle half of FIG. 11 along section line B-B;

FIG. 17 is a cross-sectional view of the handle half of FIG. 14 along section line C-C;

FIG. 18 is a cross-sectional view of the handle half of FIG. 11 along section line D-D;

FIG. 19 is an enlarged, fragmentary, perspective view of the handle half of FIG. 11 at detail B;

FIG. 20 is an enlarged, fragmentary, plan view of the handle half of FIG. 14, at detail C;

FIG. 21 is an enlarged, cross-sectional view of the handle half of FIG. 14 at detail D;

FIG. 22 is a photograph of two pairs of an exemplary embodiment of a nipper, one from a top side and one from a bottom side;

FIG. 23 is a photograph of three pairs of an exemplary embodiment of a nipper from a bottom side thereof;

FIG. 24 is a fragmentary, side elevational view of an exemplary embodiment of a coil spring of the nipper of FIGS. 5 and 11;

FIG. 25 is a fragmentary, radial cross-sectional view of the coil spring of FIG. 24;

FIG. 26 is a fragmentary, side elevational view of an exemplary embodiment of a coil spring of the nipper of FIGS. 5 and 11;

FIG. 27 is a fragmentary, radial cross-sectional view of the coil spring of FIG. 26;

FIG. 28 is a fragmentary, side elevational view of an exemplary embodiment of a coil spring of the nipper of FIGS. 5 and 11;

FIG. 29 is a fragmentary, radial cross-sectional view of the coil spring of FIG. 28;

FIG. 30 is a fragmentary, side elevational view of an exemplary embodiment of a coil spring of the nipper of FIGS. 5 and 11;

FIG. 31 is a fragmentary, radial cross-sectional view of the coil spring of FIG. 30;

FIG. 32 is a fragmentary, side elevational view of an exemplary embodiment of a coil spring of the nipper of FIGS. 5 and 11;

FIG. 33 is a fragmentary, radial cross-sectional view of a first portion of the coil spring of FIG. 32;

FIG. 34 is a fragmentary, radial cross-sectional view of a second portion of the coil spring of FIG. 32;

FIG. 35 is a fragmentary, radial cross-sectional view of a third portion of the coil spring of FIG. 32;

FIG. 36 is a fragmentary, side elevational view of an exemplary embodiment of a coil spring of the nipper of FIGS. 5 and 11;

FIG. 37 is a fragmentary, radial cross-sectional view of the coil spring of FIG. 36;

FIG. 38 is a photograph of a fragmentary perspective view of an assembling step of the coil spring of the nipper of FIGS. 5 and 11;

FIG. 39 is a photograph of a fragmentary perspective view after the assembling step of FIG. 38;

FIG. 40 is a photograph of a fragmentary perspective view after the assembling step of FIG. 38 rotated with respect to FIG. 39;

FIG. 41 is a photograph of a fragmentary perspective view after the assembling step of FIG. 38 rotated with respect to FIG. 40;

FIG. 42 is a photograph of a fragmentary perspective view of a coil spring testing step while stretching the coil spring;

FIG. 43 is a photograph of a fragmentary perspective view of a coil spring testing step after stretching the coil spring; and

FIG. 44 is a photograph of a fragmentary perspective view of an exemplary embodiment of an end of a coil spring according to the invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Described now are exemplary embodiments of the present invention. Referring now to the figures of the drawings in detail and first, particularly to FIGS. 5 to 21, there is shown a first exemplary embodiment of a nipper 500 having two handle halves 510, 510′. The handle halves 510, 510′ are identical such that, when two of the handles 510 are connected together movably by an axle 520, the two handles 510, 510′ form the nipper 500. As set forth herein, it is desirable for a nipper to have a bias device that holds the two blades 511, 511′ of the nipper 500 open or away from one another such that a closing of a user's hand, as shown in the progression of FIGS. 8 to 9/10, touches the nipper blades 511 together for nipping. In the embodiment, there is only a single part for keeping the blades 511, 511′ apart—a coil spring 530. The curved condition of the coil spring 530 when installed at the handle halves 510, 510′ retains the two handle halves 510, 510′ in an open steady-state position. Thus, when resting on a surface, the blades 511, 511′ of the nipper 100 are separated as shown, for example, in FIGS. 6, 22, and 23.

The coil spring 530 is, for example, coated by paint, plastics, gold, silver, nickel, chrome and/or any carbide or nitride coating. In an exemplary embodiment, a thickness of the material making up the coil spring 2400 is constant along the length of the spring as shown in FIGS. 24 and 25. In another exemplary embodiment, a thickness of the material making up the coil spring 2600 varies along the length of the spring as shown in FIGS. 26 and 27 where a first thickness S₁ is thinner than a second thickness S₂. Even though the rod that comprises the coil spring 2600 is shown as being thicker in diameter at the middle and thinner at the ends, this configuration can be reversed to have the thickness of the coil spring 2600 be greater at the ends thereof than at the middle thereof or the coil spring 2600 can even be made to have periodically changing diameters.

Alternatively, the outer diameter of the coil spring 2800 can be greater at the ends of the coil spring 2800 than at the middle thereof as shown in FIGS. 28 and 29. Even though the rod that comprises the coil spring 2800 is shown as being thicker in diameter at the middle and thinner at the ends, this configuration can be reversed to have the diameter of the coil spring 2800 be greater at the ends thereof than at the middle thereof or the coil spring 2800 can even be made to have periodically changing diameters.

In an alternative or additional exemplary embodiment, the cross diameter of the coil spring varies along the length of the spring.

In an alternative or additional exemplary embodiment, the cross-sectional shape of the rod comprising the coil spring is round along the length of the spring, as shown, for example, in FIGS. 6, 7, and 24 to 29.

In an alternative or additional exemplary embodiment, the cross-sectional shape of the spring is not round, for example, it is square 3000 as shown in FIGS. 30 and 31.

In an alternative or additional exemplary embodiment, the cross-sectional shape of the spring 3200 is not of constant dimensions along the length of the spring as shown, for example, in FIGS. 32 to 35.

In an alternative or additional exemplary embodiment, the cross-sectional shape of rod 3600 comprising the spring is not round along the length of the spring, for example, rectangular or ovular. An example of a rectangular rod shape is shown in FIGS. 36 and 37.

Each of these varying configurations can be used interchangeably or in any combination. Use of different numerals for the various embodiment of the coil spring 530, 2400, 2600, 2800, 3000, 3200, 3600, therefore, is not selected to limit the possibility of such combinations.

FIGS. 6 and 7 show an exemplary embodiment of the nipper 500 from above and from one side. FIG. 10 shows the nipper 500 in a hand of user with the nipper blades 511, 511′ touching.

The handle half 510 is shown in more particular detail in FIGS. 11 to 21. In particular, the handle half 510 is shown in plan view in FIG. 11. Apparent from this view is the separation between the distal section 1110 of the handle half 510, which is finished, and the proximal section 1112 of the handle half 510, which is neither grinded nor polished, due to the fact that the proximal section 1112 is entirely covered by one end portion of the coil spring 530. As used herein, finished is defined as having an exterior surface that is at least grinded or polished or both grinded and polished. Unfinished, in contrast, is an exterior surface that is neither grinded nor polished.

The distal section 1110 starts at a stop collar 1210, which in this exemplary embodiment is frusto-conical, decreasing in size away from the proximal section 1112. The distal section 1110 continues with an intermediate pivot portion 2110 and ends with a blade portion 2112, the latter terminating in the blade 511. Each of the stop collar 1210, the intermediate pivot portion 2110, and the blade portion 2112 form a finished part, including both the grinding and polishing steps.

The proximal section 1112 starts at the proximal end of the stop collar 1210 and extends proximally all the way to the proximal end 1114 of the handle half 510. The distal-most portion of the proximal section 1112 has a coil spring connector 1410, an example of which is best shown in FIGS. 14 and 19. The coil spring connector 1410 can take any form and, in this exemplary embodiment, is in the form of a hemispherical, circumferential groove entirely encircling the distal end of the proximal section 1112. The coil spring 530 in this embodiment is formed from a circular rod having an cylindrical shape corresponding to the tangential cross-section of the hemispherical groove such that, when installed on the proximal section 1112 all the way distal to the stop collar 1210, the last coil enters the groove and remains there in a form-lock. A form-locking or form-fitting connection is one that connects two elements together due to the shape of the elements themselves, as opposed to a force-locking connection, which locks the elements together by force external to the elements.

The process for assembling the coil spring 530 of the nipper 500 is shown in FIG. 38. In this depiction, the coil spring 530 is being forced onto the handle until the last coil of the coil spring 530, which is formed with a smaller diameter than other coils, snaps into place within the coil spring connector 1410.

Assisting the retention of the coil spring 530 in the coil spring connector 1410 is a securing ramp 1412 that is sized, in another exemplary embodiment, to have a diameter slightly larger than the cylindrical interior center space of the coil spring 530. In this way, installation of the coil spring 530 onto the proximal section 1112 occurs by slightly stretching the end coils outward as they are slid in the direction of the stop collar 1210. When the first coil enters the coil spring connector 1410, it is caused to spring back inwards and form-lock therein. In contrast to the last coil, the coils adjacent the first coil on the ramp portion remain slightly stretched outwards to form a force-locking or clamped connection that enhances and augments the hold of the form-locking first coil onto the proximal section 1112 to securely retain the coil spring 530 on the proximal section 1112 after installation. An alternative embodiment has the securing ramp 1412 sized to have an outer diameter equal to the inner diameter of the coil spring 530 but with the last coil having a smaller diameter as shown in FIGS. 38, 39, 40, and 41. This configuration securely attaches the coil spring 530 onto the coil spring connector, as shown in FIGS. 42 and the inset of FIG. 43 where the coil spring 530 is pulled (FIG. 42) and is allowed to spring back (FIG. 43). Due to the sure connection made, there is virtually no possibility of the user having contact with the unfinished exterior surface (which is neither grinded nor polished) inside the coil spring 530.

As an end of a typical rod forming a coil spring 530 is not flat, in an exemplary embodiment, each of the ends of the coil spring 530 can be flat, for example, by grinding as shown in FIG. 44. In this way, the last coil of the coil spring 530 will securely rest in the coil spring connector 1410. Even though the coil spring 530 will have direct contact with the shoulder of the conical stop collar 1210, there will be some gap 4000 as seen in FIGS. 40 and 41. In an exemplary embodiment, this gap 4000 is positioned in between the handle halves 510, 510′ of the nipper 500.

In one exemplary embodiment, the handle half 510′ is a minor image of the handle half 510 shown in FIGS. 11 to 21 such that at least one is movable with respect to the other about the pivot point 2114. Connection of the two handle halves 510, 510′ can be made, for example, by an axle that pierces both of the two handle halves 510, 510′ or can be a boss on one handle half 510, 510′ that extends into a correspondingly shaped recess of the other handle half 510′, 510. Once secured together so that the two handle halves 510, 510′ pivot to move the blades 511, 511′ towards and away from one another, the coil spring 530 can be installed on the proximal sections 1112, 1112′ as described herein. Various views, cross-sections, and portions of the handle half 510 are illustrated in FIGS. 11 to 21.

Manufacturing of the nipper 500 occurs by machining each of the handle halves 510, 510′ from a single blank, for example, of stainless steel. Each handle half 510, 510′ is rough formed as shown in FIGS. 11 to 21. Grinding and polishing, however, is only performed on the distal portion 1110, no grinding or polishing is performed on the proximal portion 1112. A first end of the coil spring 530 is slidably passed over the rough proximal portion 1112 and is forcibly expanded at the securing ramp 1412 until the first coil of the coil spring 530 secures at the coil spring connector 1410. Then, the coil spring 530 is bent into a U-shape and the second end of the coil spring 530 is slidably passed over the rough proximal portion 1112′ and is forcibly expanded at the securing ramp 1412′ until the first coil of the coil spring 530 secures at the coil spring connector 1410′. The coil spring 530, having tightly wound coils visually covers substantially all of the proximal portion 1112, 1112′ of the two handle halves 510, 510′. The term substantially, as it is used here, means that virtually all of the proximal portions 1112. 1112′ are not visible through the coil spring 530. The force imparted on the handle halves 510, 510′ by the installed coil spring 530 retains the handle halves 510, 510′ in the open position as shown, for example, in FIGS. 22 and 23.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A nipper, comprising:
two crossing levers movably connected at a joint, each of the levers having:
a finished distal portion having at least one blade;
an unfinished proximal portion; and
a coil-spring connector at a junction of the distal and proximal portions; and
a coil spring having a hollow interior and two ends, each of the two ends being connected to a respective coil-spring connector and visually covering substantially all of a respective proximal portion.

2. The nipper according to claim 1, wherein the coil spring is at least one of a steel alloy, an aluminum alloy, and a plastic.

3. The nipper according to claim 1, wherein the coil spring is coated by at least one of paint, plastics, gold, silver, nickel, chrome, a carbide coating, and a nitride coating.

4. The nipper according to claim 1, wherein the coil spring has a length and is of a material having a thickness that varies along the length of the coil spring.

5. The nipper according to claim 1, wherein the coil spring has a length and a cross diameter that varies along the length of the coil spring.

6. The nipper according to claim 1, wherein the coil spring has a length and a cross-sectional shape of the coil spring not of a constant dimension along the length of the coil spring.

7. The nipper according to claim 1, wherein the coil spring has a length and one of:
a round cross-sectional shape along the length of the coil spring; and
a non-round cross-sectional shape along the length of the coil spring.

8. The nipper according to claim 1, wherein the coil spring is flat at each of the two ends.

9. The nipper according to claim 1, wherein the proximal portions are plastic-coated.

10. A method for manufacturing a nipper, which comprises:
providing each of two levers with:
a nipper blade at a finished distal portion having a proximal end;
an unfinished proximal portion connected at the proximal end of the distal portion; and
a coil-spring connector at a junction of the distal and proximal portions;
movably connecting the two levers at a joint to form a nipper with the nipper blades; and
visually covering substantially all of the proximal portion of each lever by sliding each end of a coil spring over the respective proximal portion and securing each end of the coil spring at the respective coil-spring connector.

11. The method according to claim 10, which further comprises providing the two levers as two minor-symmetrical levers.

12. The method according to claim 10, which further comprises holding the nipper blades apart with the coil spring in a steady-state of the nipper.

13. The method according to claim 10, which further comprises forming the coil spring from at least one of a steel alloy, an aluminum alloy, and a plastic.

14. The method according to claim 10, which further comprises coating the coil spring with by at least one of paint, plastics, gold, silver, nickel, chrome, a carbide coating, and a nitride coating.

15. The method according to claim 10, wherein the coil spring has a length and which further comprises forming the coil spring of a material having a thickness that varies along the length of the coil spring.

16. The method according to claim 10, wherein the coil spring has a length and a cross diameter that varies along the length of the coil spring.

17. The method according to claim 10, wherein the coil spring has a length and a cross-sectional shape of the coil spring not of a constant dimension along the length of the coil spring.

18. The method according to claim 10, wherein the coil spring has a length and one of:
a round cross-sectional shape along the length of the coil spring; and
a non-round cross-sectional shape along the length of the coil spring.

19. The method according to claim 10, which further comprises flattening each of the two ends of the coil spring.

20. The method according to claim 10, which further comprises plastic coating the proximal portions.
